(19) United States
(12) Patent Application Publication
(10) Pub. No.: US 2003/0023502 A1
(43) Pub. Date: Jan. 30, 2003

(54) Business procedure for mediation of vending by competitive price assessment with minimum guarantee

(76) Inventor: Katsuhiko Senda, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/987,716

(22) Filed: Nov. 15, 2001

(30) Foreign Application Priority Data
Jul. 27, 2001 (JP) 2001-227658

(51) Int. Cl. G06F 17/60

(52) U.S. Cl. 705/26

(57) ABSTRACT

The invention discloses a novel business procedure in connection with mediation of vending of a certain objective which the vendor wishes to sell off. In the inventive procedure, the vendor presents and registers his objective for vending in a registry system operated by an operating organization and the information on the objective is disclosed to a plurality of mediator agents together with indication of a guaranteed minimum price or the amount of breach penalty payable by the mediator agent, obligatory acceptance price or amount of breach penalty by the vendor and the price for exempting the mediator from the obligation of minimum guarantee each in relation to the assessed price and the vendor is informed of the profiles of the mediator agents to pertain to bidding so as to establish matching of the vendor and the mediator agent.

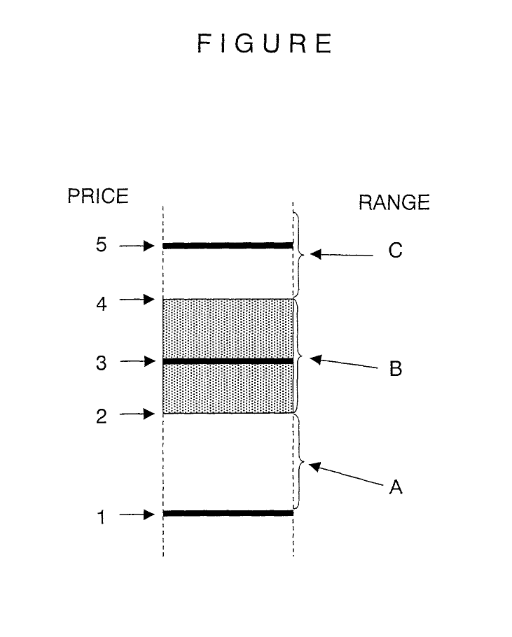

### BACKGROUND OF THE INVENTION

The present invention relates to a novel business procedure for mediation of vending by competitive price assessment with minimum guarantee between a vendor who wishes to sell an objective for sale and a mediator agent seeking commercial objectives for dealing by assisting proper matching of the vendor and the mediator agent so as to efficiently establish a higher vending price of the objective for vending.

It is a usual way that, when a person in possession of an objective for sale including real properties such as real estates, automobiles and fine art articles as well as intellectual properties such as copyrights, patents and registered trademarks and exclusive licenses or contracts wishes to sell his property, the person, referred to as a vendor hereinafter, must offer his wish to sell an objective to a mediator found out by his own effort either by visiting or by calling the mediator or by asking a visit of the mediator to the vendor and disclose the outline of the objective for vending while the mediator provides the vendor with information relative to the trend in the current market price of the objective before entering a negotiation to reach an agreement for the vending price of the objective, selling term, service fees for mediation and other conditions to be included in the contract for mediation.

The mediator as a business agent, on the other hand, must constantly continue his activity for uncovering objectives available for dealing by mediation because their business can never be materialized in the absence of objectives for dealing. Such an activity to uncover objectives for dealing requires a great deal of energy and cost by utilizing all of the available communication media including not only the mass media by printing and broadcasting but also personal media by leaflet handouts and direct mails.

It is usually the case, however, that vendors in general have little good information on the profiles of various mediator agents and mediator agents usually take no responsibility on the realizability of their assessed price which they propose to the vendor so that vendors are sometimes at a loss for selection of a reliable mediator agent who can realize the highest vending price of the vendor's property for sale. Accordingly, motivation of a vendor for selection of a mediator agent is frequently based merely on marginal information such as the personal impression and speaking manner of the sales person and appearance of the agent's office setout without any reasonable grounds. In addition, it is always very time- and energy-consuming as a great hurdle against a vendor to have a detailed negotiation with a mediator agent to reach an agreement relative to the vending price of the objective and other conditions unless the vendor has at least several experiences of such business transactions.

Even if a contract for mediation has been concluded between a vendor and a mediator agent, in addition, there is absolutely no certainty to ensure appearance of a proper buyer or candidate vendee before the mediator within the selling term agreed to by the parties sometimes necessitating renewal of the mediating contract or appointment of a new mediator agent by the vendor eventually resulting in a loss of the proper trading chance of the objective property.

### SUMMARY OF THE INVENTION

In view of the above described situations in vending by means of mediator, the present invention has an object to provide a novel business procedure of trading for vending a property by mediation of a mediator agent between a vendor and a candidate vendee, by which, on one hand, the vendor can readily and conveniently find out a reliable mediator agent capable of presenting a highly realizable vending price of the objective for vending to greatly simplify the usually very troublesome negotiation with the mediator for concluding a mediating contract and to provide the vendor with accurate estimation of actual trading term and price and, on the other hand, the mediator can be assured with an objective for dealing resulting in an increased opportunity for obtaining new customers.

Thus, the business procedure provided by the present invention for mediation of vending between a vendor for vending an objective and a mediator agent by making a competitive price assessment with minimum guarantee comprises the steps, each undertaken by the vendor, of:

(a) registering the objective for vending offered by the vendor in a registration system operated by an operating organization;

(b) selecting at least two mediator agents registered in advance as a member in the operating organization;

(c) providing the selected mediator agents with information relative to the objective for vending by mediation and ratios of a guaranteed minimum price or an amount of breach penalty payable by the mediator agent, a price for obligatory acceptance by the vendor or an amount of breach penalty payable by the vendor and the price for exemption of the mediator agent from obligation for minimum guarantee each to the assessed price to be made by the mediator agent;

(d) receiving a bid of an assessed price of the objective for vending from each of the mediator agents selected in step (b) and information on the business profile of each of the mediator agents to appoint at least one of the mediator agents for conclusion of a mediating contract; and

(e) receiving, from the appointed mediator agent, recommendation of a candidate vendee.

In case where a mediating contract including a vending term has been concluded between the vendor and the mediator agent and the mediator agent fails within the specified vending term to recommend an appropriate candidate vendee who wishes to purchase the objective at a price not lower than the aforementioned guaranteed minimum price, it is preferable that the mediator agent has an obligation to purchase the objective by himself at the guaranteed minimum price or to pay the breach penalty to the vendor. When the mediator agent could recommend an appropriate candidate vendee who wishes to purchase the objective at the price of obligatory acceptance or higher to the vendor, on the other hand, the vendor has an obligation to sell over the objective to the vendee or, if the vendor does not wish to sell over the objective to the particular candidate vendee, to pay the breach penalty payable by the vendor.

### BRIEF DESCRIPTION OF THE DRAWING

The FIGURE is a relative scheme of the prices involved in the inventive business procedure.

### DETAILED DESCRIPTION OF THE PREFERRED EMBODIMENTS

The business procedure according to the present invention is started with step (a) in which the vendor who wishes to sell a property of his possession makes access to a registration system established and operated by an operating organization organized by a number of mediator agents in various categories of objectives to deal with so as to register the objective property offered by the vendor for vending. Namely, the operating organization has a registry of a plurality of mediator agents as the members of the organization. In step (b) of the inventive procedure, at least two mediator agents, who are required to have sufficient knowledges and experiences to deal with the objective for vending, are selected by the vendor from the registered members of the operating organization.

In step (c) of the inventive business procedure, an outline of the objective for vending by mediation is disclosed to the selected mediator agents together with the information on the ratios of the guaranteed minimum price or the amount of breach penalty payable by the mediator agent, the price for obligatory acceptance by the vendor or the amount of breach penalty payable by the vendor and the price for exemption of the mediator agent from the obligation of minimum guarantee each to the assessed price so as to enable the mediator agent to have an access to the competitive registration system to obtain instructions to make a bid of an assessment of the price of the objective within a prescribed term.

A variety of data compiling systems can serve as the above mentioned competitive registration system of the objectives for vending by mediation, which can be in the form of internet home pages or an automatic e-mail distribution system such as an e-mail magazine on a computer or a facsimile distribution network system. It is of course possible that the registration system is a compilation of traditional files holding paper sheets containing information on the objectives for vending by mediation and offered for perusal by the mediator agents as a registered member of the organization in a face-to-face personal interview over the counter.

Being informed of the thus disclosed outline of the objective for vending by mediation as combined, if necessary, with the information obtained by their own investigation activities, each of the selected mediator agents prepares an assessment of the vending price of the objective and, in step (d), makes a bid for the assessed vending price. When the operating organization has received the bids from all of the selected mediator agents, the organization, in step (e), discloses, by way of an appropriate communication means, the data collected by the biddings to the vendor together with the information on the business profile of each of the mediator agents who have made biddings.

Upon receipt of the thus disclosed information on each of the selected mediator agents, the vendor now appoints at least one of the agents for the actual service of mediation which is expected to be the most satisfactory for the vendor and concludes a contract for mediation with the appointed mediator agent. In order to be incentive for competition of services including assessment of vending prices, it is optional to conclude a provisional contract with a plurality of mediator agents, of whom only one is appointed to conclude an exclusive contract after competition.

After concluding a contract for vending mediation with the vendor, the mediator agent enters ordinary sales activities to uncover an appropriate candidate vendee who deserves recommendation to the client vendor and takes care of concluding a vending contract between the parties of the vendor and the candidate vendee.

While the above given description explains the outline of operation of the inventive business procedure for vending mediation by competitive price assessment with minimum guarantee, following is a more detailed description of the inventive business procedure along the flow of the steps according to the above description.

The mediator agent who wishes to pertain to the procedure according to the invention must be registered in advance in the operating organization as a member. The system for the membership registration has an object to assure competence and capability of the agent for dealing with the mediating business in order to be responsible for the vending price assessment exhibited by bidding and to minimize troubles concerning the mediation as far as possible. The mediator agent is requested to disclose his business profile relative to vending mediation and to give consent to an operating rule prescribing that, if the mediating activity comes to an unfortunate end at a deadlock after conclusion of the mediating contract with the vendor, the mediator agent has an obligation to purchase the objective for vending by himself at a price corresponding to a certain fraction of the assessed vending price or, namely, the guaranteed minimum price under certain conditions. The mediator agent is also requested to pay a participation fee and/or membership fee to the operating organization. Alternatively, the above mentioned purchasing obligation can be replaced with an obligation to pay a breach penalty of a substantial amount.

It is a due prescription that the operating organization receives a certain amount of a contingent fee when the mediating activity of the mediator agent is terminated as a result of conclusion of a vending contract between the vendor and the candidate vendee or by purchasing the objective or payment of a breach penalty by the mediator himself. Optionally, a participation fee is payable by the mediator agent who wishes to participate to the competitive price assessment.

The disclosure of the business profile by the mediator agent should desirably include the information, in addition to the business carrier or resume given in a conventional manner, relative to the record of the agent's participation to mediation according to the procedure of this invention, percentage of the cases ended with conclusion of a vending contract, average ratio of the actual vending price to the assessed price and so on.

While, in the inventive procedure, the mediator agent is under an obligation as a guarantee to purchase the objective at a price corresponding to a certain fraction of the assessed price or to pay a breach penalty in an amount corresponding to a fraction of the assessed price, the vendor is requested to acknowledge the rule that he cannot obviate to conclude a vending contract if recommended with a candidate vendee who offers a price not lower than the price for obligatory acceptance corresponding to a certain fraction of the assessed price unless the recommended candidate vendee is a socially reproachable person or entity such as a member of a group undertaking illegal or destructive activities as a proper reason for obviating conclusion of a contract. Alternatively, a breach penalty is payable by the vendor when he wishes to obviate conclusion of a vending contract without any proper reasons.

With understanding and acknowledgement of the above described rules for the vending mediation in a competitive price assessment, the vendor makes a registration of the objective for vending in the receiving registration system of the operating organization with outline information of the objective.

The items to be included in the above mentioned outline information on the objective for vending naturally depend on the types and nature of the objective. For example, the information on a real estate should contain the location, particulars, accessing means and others including acreage, land category classification, existing buildings thereon and proprietorship when the real estate is a land and types of the house, e.g., condominium or isolated house, floorage, floor plan, facing direction, environmental conditions, parking spaces and time limit for vacating when the real estate is a living house. When the objective is a car, the information should contain the items of types of the car, model year, records of repairing, mileage and condition of mechanic maintenance and option accessories. When the objective is a fine art article, the information should contain the basic items such as the name of the artist, title of the article, size or dimensions and age of production and supplemental items such as the time of delivery and desired vending price. It is of course at the vendor's option to lay stress on the advantageous features of the objective when a higher vending price be possibly or hopefully applicable as an expectation. On the other hand, it is recommendable in some cases to disclose certain information which may adversely affect the vending price.

As is mentioned before, the type of the receiving registration system is not particularly limitative including internet home pages by utilizing computers and a traditional filing system by means of personal interview over the counter. When the objective for vending offered by the vendor is on file in the receiving registration system, the operating organization invites at least two mediator agents having membership of the organization to ask bidding of an assessed price for the objective with indication of the ratios of each of the guaranteed minimum price, the price for obligatory acceptance by the vendor and the guaranteed minimum exemption price by the mediator agent each to the assessed price along with disclosure of the outline information on the objective for vending submitted by the vendor to the operating organization.

The ratio of each of these prices to the assessed price is set by the operating organization by taking into consideration various factors such as the condition of the objective, economical situations and trend of the market. As an alternative way, the ratio of the guaranteed minimum price to the assessed price can be replaced with the ratio of the amount of breach penalty payable by the vendor to the assessed price. It is of course optional to indicate both of these ratios. Likewise, the ratio of the price for obligatory acceptance by the vendor to the assessed price can be replaced with the ratio of the amount of breach penalty payable by the vendor to the assessed price. Both of these two ratios can also be indicated jointly.

The guaranteed minimum price mentioned above means the price at which the mediator agent purchases the objective by himself as an obligation in an event when no vending contract can be concluded between the vendor and the recommended candidate vendee notwithstanding the mediating activity undertaken by the mediator agent. The breach penalty payable by the mediator agent is a monetary penalty which the mediator agent pays to the vendor as an obligation in an event when no vending contract can be concluded between the vendor and the recommended candidate vendee. In the present invention, the mediator agent may be jointly under these two obligations, generally referred to as the purchasing obligation.

In an event that no vending contract of the objective can be concluded between the vendor and the candidate vendee notwithstanding the mediating activity of the mediator agent, it is basically at the vendor's option whether the mediator agent is requested to purchase the objective by himself or to pay the breach penalty. This optional selection of the mediator's obligations can be expressed at the moment of registration of the objective or can be made at the moment of appointing the mediator agent. This way of setting the guaranteed minimum price and setting of the breach penalty relative to the assessed price is unique and never undertaken in the conventional mediating procedures.

Even in the case where the mediator agent can recommend a promising candidate vendee to the vendor, his client, the vendor, still has an option of refusing the recommended candidate vendee. The agreement for this option, however, should be made after deliberate consideration since otherwise the mediator agent is under a one-side risk that his mediating activity is fruitless resulting in eventual disadvantage of the purchasing obligations on the mediator agent.

The vending price for obligatory acceptance by the vendor is the price at which the vendor is not entitled to refuse a contract for vending the objective to the recommended candidate vendee who offers a purchasing price not lower than this obligatory vending price. Setting of this obligatory vending price has an effect to ensure alleviation of the risk at the mediator agent that the agent is under a one-side disadvantage of a fruitless outcome of his mediating activity. It is of course optional that setting of the above mentioned obligatory vending price, which binds the vendor to conclude a vending contract, is replaced with a vendor's obligation to pay a breach penalty so that the vendor is entitled to refuse a vending contract irrespective of the purchasing price offered by the recommended candidate vendee.

Although it should basically be after an agreement between parties of the mediating contract whether the vendor has an obligation to conclude a vending contract with the recommended candidate vendee or the vendor has an obligation to pay a breach penalty, it is desirable that the final choice for this option is at the vendor's side.

The price for exemption of minimum-guarantee obligation, which can be lower than the obligatory vending price for the vendor, is set as a minimum price by which the mediator agent is exempted from carrying out the purchasing obligations on him.

It is at the vendor's option to refuse conclusion of a vending contract when the recommended vendee offers a purchasing price which is within the price range between the price for exemption of the minimum-guarantee obligation as the upper limit and the guaranteed minimum price as the lower limit. In this case, the mediator agent is still under the purchasing obligations. This can be construed to be a penalty-equivalent for failure of recommending a more promising vendee. Needless to say, the vendor is under a possible disadvantage of a decrease in the actual delivery price of the objective. It is optional in this case, however, when the mediating contract sets out exclusive application of the purchasing obligations on the mediator agent, that the mediator agent is exempted from the purchasing obligations.

The invitation term for bidding of the assessed price by the mediator agents can be set appropriately by the operating organization, for example, for 3 days, 7 days or longer. When the objective for vending is disclosed to the competitive registration system, each of the mediator agents makes bidding of his assessed price in consideration of several surcharges determined by multiplying the assessed base price by a certain factor after making reference to the disclosed outline of the objective and, if necessary, the results of his own investigations.

Since the rule is for automatic setting of the guaranteed minimum price by multiplying the assessed price as set out by a certain factor, the mediator agent takes the risk of self-purchasing of the objective for mediation necessarily leading to bidding of an assessed price for which he can take more responsibility so that the vendor can be provided with a more realizable assessed price. A mediator agent would be able to make bidding for a relatively high assessed price if the agent has accessibility to abundant information on the objective and has already prepared a list of prospective candidate vendees. On the other hand, a mediator agent who has little personal information on the objective for vending such as the information on a prospective candidate vendee having a particular wish to purchase, for example, the real estate as the objective for vending is necessarily inclined to make a bidding with a relatively low assessed price in order to obviate the risk accompanying a high assessed price.

It is also an alternatively possible and feasible way to estimate the assessed price by a backward calculation from the standpoint of securing an appropriate profit by adequately setting the guaranteed minimum price as the base for the price assessment in view of the advanced setting of the multiplication factor.

If necessary, the mediator agent has an option in the bidding to indicate the term during which the agent wishes to develop his mediating activity. When the bidding term is over, the operating organization compiles the results of the biddings to inform the vendor of the results together with the registered profile data of each of the mediator agents who have made biddings. The vendor provided with the information now selects and appoints a mediator agent to whom the vendor can expect to receive the best service of mediation for fully satisfying the desired vending conditions leading to conclusion of a contract for mediation.

The contract for mediation can be either an exclusive contract which prohibits the vendor from making a contract with other mediator agents or an ordinary contract without such a prohibiting term. Although the concept or term of exclusive contract is usually understood in connection with the business in trading of a real estate, the applicability of this concept or term can be extended to other cases where the objective for trading is not a real estate as is sometimes the case in the present invention.

Since the assessed price of the objective is presented to the vendor in a procedure of competitive bidding, the vendor is afforded to have an advantage of objectively obtaining information on the estimation of the actual market price of his objective for vending.

While it is at the choice of the operating organization whether the mediation contract is in the form of an exclusive mediation contract or in the form of an ordinary mediation contract, agreements should be made between the parties for the contract basically on the matters whether the minimum guarantee by the mediator agent is made by the obligation for purchasing the objective by himself or by payment of a breach penalty, and, when a vender offers a vending price not lower than the vending price desired by the vendor, whether the vendor has an obligation to accept the offered price or has a right to refuse the offered price with payment of a breach penalty.

Besides the effective term for mediation, which is an indispensable item to be included in a mediation contract, the mediation contract can specify various other conditions such as, assuming that the objective for vending is a real estate, the extent to which the particulars of the vending objective are disclosable and the extent to which advertising activities can be admitted. This is because some vendors of a real estate sometimes do not wish, depending on their circumstances, to inform those having interest on the real estate, such as the neighborhood people of the real estate, of the fact that the real estate is now an objective on sale.

When a mediation contract has been concluded between parties, the mediator agent now has to notify the operating organization of this fact. It can sometimes be the case that, in the course of contract making for mediation, the operating organization takes a consultation service for the parties or, in particular, for the vendor of the objective.

When a contract for mediation has been concluded between the parties, the mediator agent prepares a specification and detailed descriptions of the objective for vending, if necessary, accompanied by a photograph and/or a rough sketch of the objective and, after setting the vending price, starts his advertising activity according to the prescription in the contract for mediation. It is possible in this advertising activity to utilize the registry system for public presentation operated by the operating organization within the limitation of the mediation contract. It is of course possible to utilize the receiving registration system, though dependent on the policy of the operating organization.

The vending price must be set so as to reflect the position of the vendor who may wish that the vending price should desirably be as high as possible or should be so low as to be attractive for an eventual candidate vendee. Since it is usual in any trading negotiations that the candidate vendee requests certain discounting below the offered vending price, a margin compensating for discounting should be taken into consideration beforehand.

When a candidate vendee has made his appearance, the mediator agent recommends the candidate vendee to the vendor according to a usual procedure. The vendor is now in a position that he should conclude a vending contract with the recommended candidate vendee or not by taking into consideration the nature of the recommended candidate vendee and the vending price he offers. By virtue of presetting of the price for obligatory acceptance by the vendor and the price for exemption of minimum guarantee obligation as is mentioned before, the vendor can be led to a decision for concluding a vending contract with ample information on which he can make a comparison of the balance between a foreseeable risk and the possibility of favorable outcome of the procedure.

When a trading contract has been concluded between the vendor and the vendee to establish actual trading, the mediator agent reports the outcome to the operating organization with payment of a contingent fee assuming that a prescription therefor is included in the rule.

If the mediator agent fails to recommend a candidate vendee within the prescribed effective term prescribed in the mediating contract, the mediator agent has to carry out the obligation of purchasing the objective by himself according to the items of the mediation contract. If no trading contract could be concluded ultimately between the vendor and the candidate vendee despite recommendation of a candidate vendee, the mediator agent is also requested to carry out the obligation of purchasing the objective by himself excepting for the case where the prescription of exemption is applicable. When the prescription of exemption is applicable, the mediation contract is terminated and the mediator agent is deprived of the right to handle the objective for mediation any longer. Assuming that the mediating contract includes an appropriate prescription, the mediator agent can receive payment from the vendor for the costs incurred in the mediating activities and an appropriate amount of service charge. In the case of carrying out the purchasing obligation, the mediator agent reports this outcome to the operating organization with payment of an appropriate “contingent” fee according to the rule.

While each of the mediator agents participating to the competitive bidding of the assessed price of the vending objective pays an entry fee, at least a part of the collected entry fees can be appropriated for the running costs of the operating organization. Alternatively, a certain fraction of the collected entry fees is returned as a lump sum to the mediator agents as a group so as to reduce the risk on the mediator agents or, further alternatively, is used for reducing the mediating service charge which the vendor pays to the mediator agent to be left at the good discretion of the mediator agent. This latter alternative is a way to promote participation of vendors to the inventive mediating procedure. Namely, it is a recommendable way that the collected amount of the entry fees to the competitive bidding of the assessed price is utilized for increasing the number of the mediator agents participating to the inventive procedure with increased attractiveness or for promoting the vendors' desire to participate to the inventive procedure.

The FIGURE of the accompanying drawing is a schematic diagram for visualizing the relationship among the various prices and price ranges appearing in the above-given description of the invention, Taking the assessed price 3 for bidding made by the mediator agent, who is a member of the operating organization, as the base, the price 2 for exemption of the minimum guarantee obligation is lower than the assessed price 3 and the minimum price 1 guaranteed by the mediator agent is still lower than the exemption price 2 while the price 4 for obligatory acceptance by the vendor is higher than the assessed price 3 and the price 5 to be presented to the candidate vendee is still higher than the price 4 for obligatory acceptance.

As is understood from the FIGURE, the guaranteed minimum price 1, the exemption price 2 and the price 4 for obligatory acceptance or the amount of breach penalty payable by the vendor are each set by multiplying the assessed price 3 by a certain factor along with setting of the vending price to be offered to the vendee. If a vending price higher than the price 4 for obligatory acceptance or the amount of breach penalty payable by the vendor is accepted by the candidate vendee, the vendor is not entitled to refuse conclusion of a vending contract unless the vendor assumes the obligation to pay a breach penalty. On the other hand, if the vendor refuses to conclude a vending contract for the reasons that the price presented by the candidate vendee is lower than the price 4 for obligatory acceptance or the amount of the breach penalty payable by the vendor but higher than the exemption price 2, the mediator agent is exempted from the obligation of purchasing the objective by himself.

If the vendor refuses conclusion of a vending contract in the case where the candidate vendee presents a price which is lower than the exemption price 2, the mediator agent is not exempted from the obligation of minimum guarantee or purchasing although it is optional to set exceptions in this case. Namely, the price range A in the FIGURE is the range in which the vendor has option of acceptance of the price and the mediator agent is not exempted from the obligation of minimum guarantee even if the vendor refuses acceptance of the price. The price range B is the range in which the vendor has option to accept the price or not but, in an event that the vendor refuses acceptance of the price, the mediator agent is exempted from the obligation of minimum guarantee. The price range C is the range in which the vendor has to conclude a contract with the vendee at the price.

There can be assumed four phases in the inventive procedure depending on the setting mode of prices breach penalties including:

Phase I in which setting is made for the guaranteed minimum price 1 by the mediator agent and the price 4 for obligatory acceptance by the vendor;

Phase II in which setting is made for the amount of the breach penalty payable by the mediator agent and the price 4 for obligatory acceptance by the vendor;

Phase III in which setting is made for the guaranteed minimum price 2 by the mediator agent and the amount of the breach penalty payable by the vendor; and

Phase IV in which setting is made for the amount of the breach penalty payable by the mediator agent and the amount of the breach penalty payable by the vendor.

The Phase I is often undertaken when the vendor wishes to sell off the objective at an early opportunity. The Phase II is sometimes undertaken when the vendor is concerned about the vending price so as to avoid an unduly low vending price. The Phase III is undertaken mainly when the mediator agent is highly interested in the objective such that the agent rather wishes to purchase the objective by himself. The Phase IV is undertaken when the vendor's first concern is to accomplish the desired vending price without minding a delay in the vending procedure.

What is claimed is:

1. A business procedure for mediation of vending between a vendor for vending an objective and a mediator agent by making a competitive price assessment with minimum guarantee which comprises the steps, each undertaken by the vendor, of:
(a) registering the objective for vending offered by the vendor in a registration system operated by an operating organization;
(b) selecting and appointing at least two mediator agents registered in advance as a member in the operating organization;
(c) providing the selected mediator agents with information relative to the objective for vending by mediation and ratios of a guaranteed minimum price or an amount of breach penalty payable by the mediator agent, a price for obligatory acceptance by the vendor or an amount of breach penalty payable by the vendor and the price for exemption of the mediator agent from obligation for minimum guarantee each to the assessed price to be made by the mediator agent;
(d) receiving a bid of an assessed price of the objective for vending from each of the mediator agents selected in step (b) and information on the business profile of each of the mediator agents to appoint at least one of the mediator agents for conclusion of a mediating contract; and
(e) receiving, from the appointed mediator agent, recommendation of a candidate vendee.

2. The business procedure for mediation of vending as claimed in claim 1 in which, after conclusion of a mediating contract in step (d), the appointed mediator agent has an obligation to purchase the objective for vending by himself at the guaranteed minimum price or to pay the breach penalty payable by the mediator agent to the vendor if the mediator agent fails to recommend a candidate vendee who wishes to purchase the objective at a price not lower than the guaranteed minimum price.

3. The business procedure for mediation of vending as claimed in claim 1 in which, after conclusion of a mediating contract in step (d) and recommendation of a candidate vendee who wishes to purchase the objective at a price not lower than the guaranteed minimum price in step (e), the vendor has an obligation to pay the breach penalty payable by the vendor to the mediator agent if the vendor refuses to vend off the objective to the recommended vendee.
